(19) United States
(12) Patent Application Publication
(10) Pub. No.: US 2017/0357052 A1
(43) Pub. Date: Dec. 14, 2017

(54) MULTI-MODE WAVEGUIDE USING SPACE-DIVISION MULTIPLEXING

(71) Applicant: THE REGENTS OF THE UNIVERSITY OF CALIFORNIA, Oakland, CA (US)

(72) Inventors: Andrew GRIECO, La Jolla, CA (US); Yeshaiahu FAINMAN, San Diego, CA (US); George PORTER, San Diego, CA (US)

(73) Assignee: THE REGENTS OF THE UNIVERSITY OF CALIFORNIA, Oakland, CA (US)

(21) Appl. No.: 15/543,557

(22) PCT Filed: Jan. 15, 2016
(86) PCT No.: PCT/US2016/013690

§ 371 Date: Jul. 13, 2017

Related U.S. Application Data
(60) Provisional application No. 62/104,550, filed on Jan. 16, 2015.

(51) Int. Cl. G02B 6/14; G02B 6/125; H04J 14/04; G02F 1/313; G02B 6/122; G02B 6/12

(52) U.S. Cl. CPC G02B 6/14; G02F 1/313; G02B 6/1228; G02B 6/125; H04J 14/04; G02B 2006/12038; G02B 2006/12061

(57) ABSTRACT

A multi-mode optical waveguide device is formed from a plurality of periodically structured waveguides, where each waveguide is configured to guide a carrier signal comprising one spatial mode of a plurality of spatial modes and has at least one segment of each waveguide with a waveguide width that periodically changes along a waveguide path to induce coupling between pairs of spatial modes. In some embodiments, the at least one segment is disposed at a location along the waveguide path at which maximal mode overlap occurs. The waveguide device may be used as for space-division multiplexing and as an optical switch.

### RELATED APPLICATIONS

This application claims the benefit of the priority of U.S. Provisional Application No. 62/104,550, filed Jan. 16, 2015, which is incorporated herein by reference in its entirety.

### GOVERNMENT RIGHTS

The present invention was made with government support under Grant No. Y502629 (EEC-0812072) awarded by the National Science Foundation. The government has certain rights in the invention.

### FIELD OF THE INVENTION

The present invention relates to a system and method for multiplexing multiple carrier signals into a waveguide by using different guided spatial modes supported by the waveguide.

### BACKGROUND

The widespread adoption of cloud computing has led to the construction of data center networks that support up to hundreds of thousands of servers, requiring internal communications at high server-to-server, or bi-section, bandwidths that are orders of magnitude greater than their connections to end users. These networks must scale with the rapid growth in user demand while keeping cost and energy requirements low. The conventional solution for this problem, wavelength-division multiplexing (WDM) in single-mode fiber links, suffers from a number of complex scaling challenges ranging from the cost of discrete WDM components to thermal management issues. To better support data center traffic, several recent efforts have begun to examine the suitability of building hybrid networks, which include both electrical packet switches (EPS) and reconfigurable optical circuit switches (OCS).

Initial deployments have shown that the reconfiguration switching time of the photonic switch is critical to support rapidly-changing traffic patterns such as all-to-all and gather/scatter traffic patterns present in large-scale applications such as MapReduce and web search. Recently, a fast OCS switch called Microsecond Optical Research Datacenter Interconnect Architecture (MORDIA) has been constructed and demonstrated. FIG. 1A provides an exemplary system-level block diagram of a MORDIA network 100, while FIG. 1B diagrammatically illustrates the components inside one station 102 of the ring. The MORDIA system is based on a wavelength-selective switch (WSS) with switching speed on the order of ten microseconds. At this speed, it can support traffic at the Top-of-Rack (ToR) switch.

It is evident that next generation Data Centers will greatly benefit from integrating the costly discrete components on a single chip. For example, MORDIA, the fast OCS hybrid network system for datacenters, could be integrated on the silicon-on-insulator (SOI) material platform by combining CMOS compatible monolithic integration (e.g., modulators, add/drops, filters, detectors, etc.) with heterogeneously integrated III-V compound semiconductor laser sources on a wavelength-division multiplexing (WDM) grid. However, it should be noted that such an integrated system would be costly and complex due to the need to integrate and control the laser sources, remove heat, and stabilize the system for operation in practical environments (e.g., temperature stabilization, monitoring the lasers and receivers on WDM grid, etc.). In this context, it is worthwhile to consider space-division multiplexing (SDM) as an alternative to augment or replace WDM.

The concept of SDM, also known by the equivalent term mode-division multiplexing (MDM), has been known in the context of guided wave optics for decades. The earliest experimental demonstrations occurred in optical fiber with the same underlying motivation as today, namely the desire to improve the transmission capacity of optical networks. In multimode fiber (MMF) this approach has proven to be unfeasible for a number of reasons, including: difficulty in selectively exciting the modes of a MMF, crosstalk caused by mode coupling due to bending or other perturbations of the MMF, and mode dispersion which severely limits the data rates that can be achieved given the typical fiber propagation length.

The advent of integrated photonics has provided a platform free of the limitations that prohibit SDM in fiber systems. Specifically, the integrated photonic chip platform is stable and crosstalk resistant, and the propagation lengths involved are short. Furthermore, since SDM and WDM operate using separate degrees of freedom, combining such systems multiplies the available channel density for minimal overhead.

Selective mode excitation on an integrated photonic chip has been demonstrated in a number of ways, including the use of multimode interference couplers, asymmetric Y-couplers, photonic crystals, and an elaborate arrangement of ring resonators. It is also possible using nonlinear optical effects. Nonetheless, practical adoption of these technologies has been stymied by a number of drawbacks. These include issues such as large device footprints that result in low packing density, a limited number of accessible high order modes, limited channel bandwidth, and a level of complexity that inhibits system design.

The prospect of developing integrated space-division multiplexing SDM promises a substantial reduction in the cost and complexity of networking systems through the augmentation or replacement of wavelength-division multiplexing WDM. Furthermore, the method is also compatible with the existing multiplexing schemes such as WDM. Combining such systems would multiply the available degrees of freedom for minimal complexity and cost overhead.

### BRIEF SUMMARY

Rather than relying on multiple wavelengths as in the prior art, the inventive approach employs the orthogonal spatial modes supported by a multimode waveguide, where each server can be assigned to transmit on a specific spatial mode excited from a drop port. Similarly, its receiver will be supplied by a spatial mode drop port. The servers will then be able to use inexpensive standard transceivers transmitting information on the same standard laser carrier, substantially reducing the cost of the whole system.

According to embodiments of the invention, a hybrid network including both electrical packet switches (EPS) and reconfigurable optical circuit switches (OCS) utilizes photonic components that reside on a chip. In an exemplary embodiment, a periodically structured coupler is configured to selectively transfer energy between waveguide modes. Compared to alternative schemes this device possesses advantages in terms of packing density, bandwidth freedom, and channel support.

In one aspect of the invention, a number of carrier signals are multiplexed into a waveguide by using the different guided spatial modes supported by the waveguide. The coupling between arbitrary modes is accomplished by periodically structuring the waveguides. The propagation directions of the coupled modes may be arbitrary. The invention may also function as a switch by varying the mode coupling strength, which may be controlled by varying the physical dimensions or refractive index of the waveguide.

In another aspect of the invention, a multi-mode optical waveguide device comprises a plurality of periodically structured waveguides disposed adjacent each other on a substrate, each waveguide configured to guide a carrier signal comprising one spatial mode of a plurality of spatial modes, wherein at least one segment of each waveguide has a waveguide width that periodically changes along a waveguide path to induce coupling between pairs of spatial modes. In some embodiments, the at least one segment is disposed at a location along the waveguide path at which maximal mode overlap occurs. The waveguide device may be fabricated on a silicon-on-insulator substrate, with the waveguide comprising a silicon core and a silicon dioxide cladding. The periodic change in the waveguide width may correspond to a step function.

In still another aspect of the invention, a multi-mode waveguide device for multiplexing a plurality of carrier signals having a plurality of spatial modes comprises a plurality of waveguides, where each waveguide is configured to guide a carrier signal comprising one spatial mode of the plurality of spatial modes, each waveguide having a waveguide path wherein at least a portion of the waveguide path has formed therein a plurality of periodic perturbations configured to induce coupling between pairs of spatial modes of the plurality of spatial modes. The portion of the waveguide having the plurality of periodic perturbations may be disposed at a location along the waveguide path at which maximal mode overlap occurs. The waveguide device may be fabricated on a silicon-on-insulator substrate, with the waveguide comprising a silicon core and a silicon dioxide cladding. The periodic change in the waveguide width may correspond to a step function.

In yet another aspect of the invention, a method for multiplexing a plurality of carrier signals comprising a plurality of different spatial modes includes inputting each carrier signal into an input port of a waveguide of a plurality of waveguides, each waveguide having a waveguide path wherein at least a portion of the waveguide path has formed therein a plurality of periodic perturbations configured to induce coupling between pairs of spatial modes of the plurality of spatial modes.

The inventive approach increases the data transfer capacity of a waveguide using the degree of freedom provided by multiple guided spatial modes by associating one carrier signal with each spatial mode. It is distinct from, but compatible with, other multiplexing techniques that operate using a different degree of freedom, e.g., wavelength-division multiplexing (WDM) that uses spectral modes supported by the waveguide.

The inventive SDM coupling approach advantageously minimizes optical loss by limiting the perturbations to the space where the modes maximally overlap. For integrated waveguides the dominant source of loss is scattering produced by roughness in the waveguide sidewalls. Consequently, increasing the waveguide dimensions will actually reduce loss because less of the mode overlaps with the waveguide sidewalls. This can be contrasted with prior art single mode couplers, which devices have perturbations on the outside of waveguides where the mode overlap is negligible. As a result, the contribution of such perturbations to the coupling coefficient is negligible while the loss contributions from increased sidewall area is nontrivial.

In an aspect of the invention, an optical waveguide uses physical perturbations of the waveguide path to selectively mix optical signals in real time to realize a number of several useful applications. Among the many potential applications of the technology are three main immediate commercial applications of the invention. The first is as a stand-alone multiplexer. The commercial incarnation of the device will most likely be passive, or operate using slow (millisecond to microsecond) switching technology (e.g., the thermo-optic effect). In this capacity, the device will function as any other standard removable optical component. The second is as an integrated multiplexer and high speed switch hybrid. A commercial version of the inventive device will preferably operate using a fast (nanosecond) switching technology (e.g., carrier injection). In this capacity the device will function as an all optical packet switch and may functionally replace the electronic top of the rack switch. The third is as an optical crossbar switch that can efficiently route incoming optical signals to the appropriate out-bound channels, whether one-to-one or one to many, with broad applications in telecommunications and internet data trafficking.

### BRIEF DESCRIPTION OF THE DRAWINGS

FIGS. 1A and 1B are a system-level block diagram of an exemplary prior art MORDIA hybrid network and the components comprising one station of the ring.

FIG. 2 is a schematic of a hybrid switch architecture according to an embodiment of the invention.

FIG. 3A is a microscope image of the periodically structured mode selective coupler according to an embodiment of the invention. The inset is an SEM micrograph showing the periodic waveguide perturbation. (Scale bar=500 μm.)

FIG. 3B is a diagrammatic view of an embodiment of a periodic waveguide section.

FIGS. 4A-4F are diagrammatic illustrations of steps within an exemplary fabrication process.

FIG. 5 is a diagrammatic illustration of an experimental setup.

FIGS. 6A-6D show the theoretical and experimental mode profiles of the SDM, where FIG. 6A shows a theoretical mode profile (unnormalized) of output Port 3 at 1475 nm wavelength; FIG. 6B shows an experimental mode profile of output Port 3 at 1475 nm wavelength; FIG. 6C shows a theoretical mode profile (unnormalized) of output Port 1 at 1490 nm wavelength; and FIG. 6D provides an experimental mode profile of output Port 1 at 1490 nm wavelength.

FIG. 7 shows the experimental transmission spectra of the periodically structured mode coupler. The port listing corresponds to that of FIG. 3.

FIG. 8 shows the mode density of a square silicon-on-insulator waveguide. The mode density is calculated for a free-space wavelength of 1550 nm, a core refractive index of 3.48 (corresponding to silicon) and a cladding refractive index of 1.46 (corresponding to silicon dioxide).

FIG. 9 shows diagrammatic top views of examples of periodically structured waveguide mode couplers for co-propagating and counter-propagating fields. The phase matching condition is listed to the left of the diagrams.

FIG. 10 diagrammatically illustrates an exemplary MDM device using counter-propagating mode selective couplers.

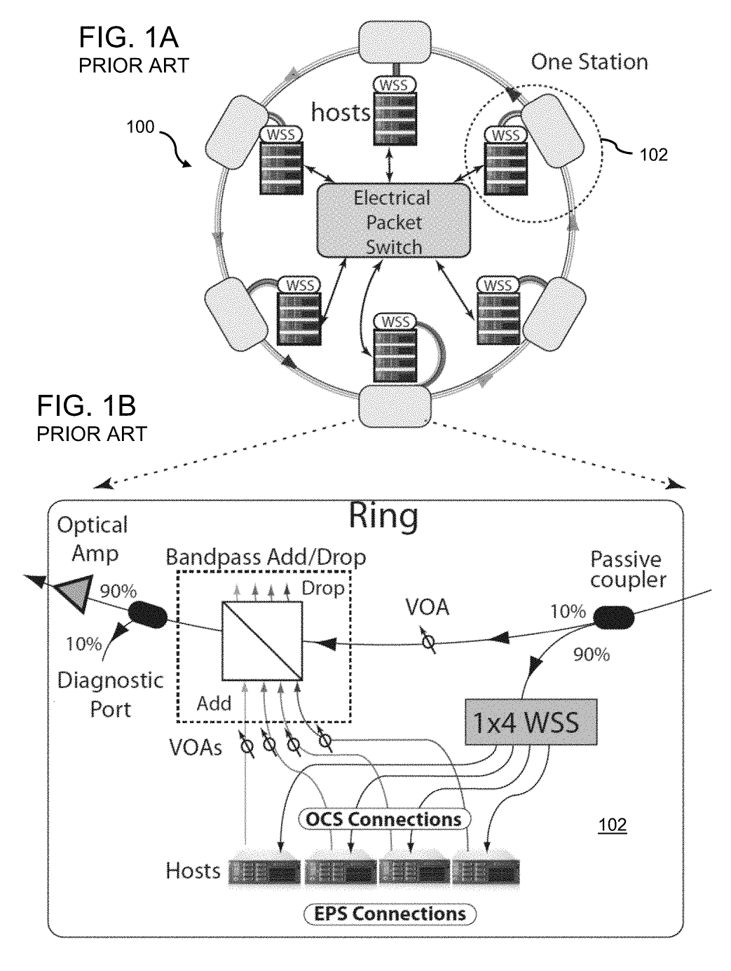

### DETAILED DESCRIPTION

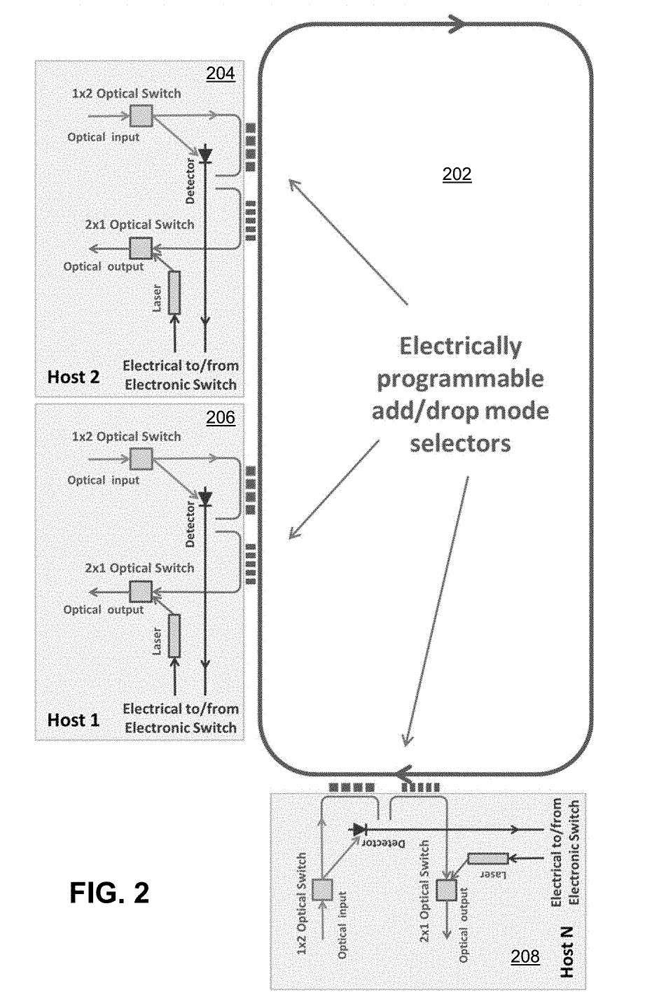

FIG. 2 illustrates provides an example of a hybrid SDM photon chip architecture incorporating the inventive technology. The architecture follows the structure of a MORDIA datacenter such as described by Farrington, et al. in “A 10 μs Hybrid Optical-circuit/Electrical-Packet Network for Datacenters,” Proc. IEEE/OSA Fiber Commun. Conf., March 2013, Paper OW3H.3, and Farrington, et al., “Hunting Mice with Microsecond Circuit Switches,” in ACM HotNets, Redmond, Wash., 2012, each of which is incorporated herein by reference. The switch includes an electronic packet switch 202 with j hosts, “Host 1” 204, “Host 2” 206, and “Host N” 208. In embodiments of the invention, a number of carrier signals are multiplexed into a waveguide by using the different guided modes of the waveguide. The coupling between arbitrary modes is accomplished by periodically structuring the waveguides. The effect of periodically structuring the waveguide may be described using the paradigm of the electromagnetic coupled-mode theory. (See, e.g., H. Kogelnik, “2. Theory of Dielectric Waveguides,” in Integrated Optics (Topics in Applied Physics), Berlin, Del., Springer-Verlag, 1975, pp. 3-81; A. Yariv and P. Yeh, Optical Waves in Crystals: Propagation and Control of Laser Radiation, John Wiley & Sons, Hoboken, N.J., 2003.) In this context the permittivity ε(x,y,z) of the waveguide is represented as a Fourier series ε(x,y,z)=εm(x,y)·exp(−i·m·2π/Λ·z), where m is an integer and Λ is the period of the perturbation. The full solution of Maxwell's equations is then written as a combination of the modes of the unperturbed z-invariant waveguide described by the 0^{th} order term ε₀(x,y) of the Fourier series. The effect of the periodic structuring is thus to transfer energy from one mode to another, although the transfer is generally not significant unless the difference between the wavenumbers of the interacting modes is approximately equal to m·2π/Λ for some m. This is known as the longitudinal phase matching condition (“LPMC”).

Each periodic structure in a waveguide typically only induces coupling between a single pair of modes. This is because the number of other propagating modes is limited, and their wavenumbers are not generally longitudinally phase matched by any grating order, allowing the coupling into these modes to be neglected. Likewise, any energy that is coupled into radiating modes rapidly leaves the waveguide and may be accounted for as propagation loss. In the absence of loss, the differential equations that govern the interacting mode field amplitudes A₁ and A₂ are:

$$\frac{{dA}_{1}}{dz} = - i \frac{{β}_{1}}{\vert {β}_{1} \vert} {κ}_{1} \cdot {A}_{2} \cdot exp ( i \cdot Δβ \cdot z ) \\ \frac{{dA}_{2}}{dz} = - i \frac{{β}_{2}}{\vert {β}_{2} \vert} {κ}_{2} \cdot {A}_{2} \cdot exp ( - i \cdot Δβ \cdot z ) . \\ Δβ = {β}_{1} - {β}_{2} - m \frac{2 π}{Λ} \qquad ( 1 )$$

The β coefficients indicate modal wavenumber. The coupling coefficients κ represent the strength of the interaction caused by the periodic structure, and are a function of the m^{th} Fourier series component of the permittivity, and the extent to which it overlaps with the electric field vectors E(x,y) of the interacting modes:

$${κ}_{1 , 2} = \frac{ω}{2} \frac{{\int }_{- ∞}^{∞} {\int }_{- ∞}^{∞} {ɛ}_{\pm m} ( x , y ) {E}_{2 , 1} ( x , y ) \cdot {{E}_{1 , 2} ( x , y )}^{*} dxdy}{\frac{{v}_{1 , 2}}{2} {\int }_{- ∞}^{∞} {\int }_{- ∞}^{∞} {ɛ}_{0} ( x , y ) {E}_{1 , 2} ( x , y ) \cdot {{E}_{1 , 2} ( x , y )}^{*} dxdy} . \qquad ( 2 )$$

The ω and ν coefficients indicate the angular frequency and energy velocity of the optical field, respectively.

The exact solution of equation (1) depends on whether the interacting fields are co-propagating or counter-propagating. In the counter-propagating case, the solution for a structure of length L may be expressed in terms of a coefficient of reflection r and a coefficient of transmission t:

$$r = \frac{{A}_{2} ( 0 )}{{A}_{1} ( 0 )} = \frac{- i \cdot {κ}_{2} \cdot L}{\frac{i \cdot Δβ \cdot L}{2} + \frac{s \cdot L}{tanh ( s \cdot L )}} \\ t = \frac{{A}_{1} ( L )}{{A}_{1} ( 0 )} = \frac{\frac{s \cdot L \cdot exp ( \frac{i \cdot Δβ \cdot L}{2} )}{sinh ( s \cdot L )}}{\frac{i \cdot Δβ \cdot L}{2} + \frac{s \cdot L}{tanh ( s \cdot L )}} . \\ s = \sqrt{{κ}_{1} \cdot {κ}_{2} - {( \frac{Δβ}{2} )}^{2}} \qquad ( 3 )$$

For a modal field incident on the periodic structure the coefficient of reflection indicates the fraction of field amplitude coupled into the counter-propagating mode. Likewise, the coefficient of transmission indicates the fraction of the incident modal field amplitude that exits the periodic structure.

A number of general observations may be drawn from equation (3). The coefficients of reflection and transmission have a spectral dependence. In the absence of loss, the points Δβ²=4·κ₁·κ₂ give s=0 and are conventionally described as the edges of the reflection band (although the reflection is technically nonzero at these points). True reflection null points occur when s·L=n·i·π for integers n≠0, which causes the hyperbolic tangent to vanish. In contrast, the maximum reflection occurs at the center of the reflection band where Δβ=0. Since κ₁, κ₂, Δβ, and L are engineered quantities it is possible to exert control over every aspect of the reflection band.

In the appropriate limits equation (3) describes a broad range of phenomena, including Bragg reflection, evanescent coupling, and dispersion engineering. Notably, conventional applications have been limited to coupling within or between single mode waveguides. However, from close inspection of equations (1) through (3) it is clear this need not be the case. Formally, it is possible to couple any two modes that overlap spatially with the dielectric perturbation. In general, guided modes have exponentially decaying tails that lie outside of the waveguide core, so this mechanism includes coupling modes within a single multimode waveguide, and coupling multiple modes of adjacent multimode waveguides. The opportunities afforded by coupling in multimode waveguides form the basis for the inventive SDM device.

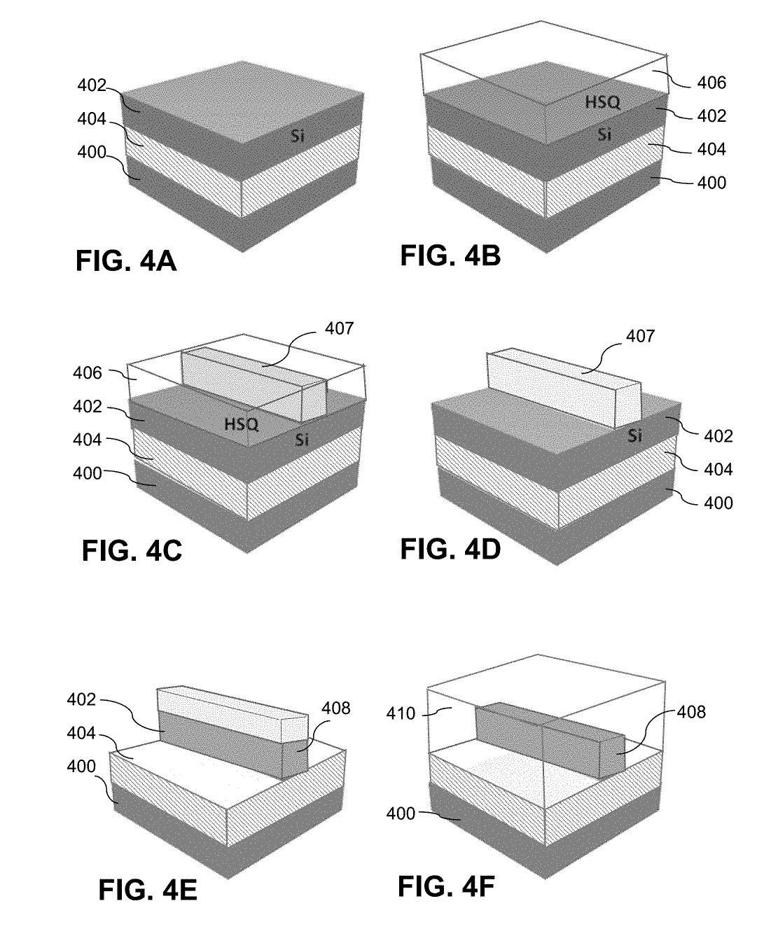

An exemplary process for fabricating an embodiment of the inventive waveguide device is illustrated in FIGS. 4A-4F. The waveguides are created from a silicon-on-insulator (SOI) substrate 400 with a 220 nm silicon top layer 402 in [100] orientation, and a 3 μm buried oxide layer 404 composed of thermally grown silicon dioxide (FIG. 4A). The substrate is then spin coated with a layer of hydrogen silsesquioxane (HSQ) electron beam resist 406 (FIG. 4B), and the desired features are defined in the resist 406 by electron beam lithography (FIG. 4C). The exposed resist 407 is developed in a tetramethylammonium hydroxide solution (FIG. 4D). The waveguides 408 are then formed by an inductively coupled plasma reactive-ion etch (FIG. 4E). The sample is then cladded with a layer of plasma-enhanced chemical vapor deposition silicon dioxide 410 (FIG. 4F), and the waveguides are exposed by dicing. It is not necessary to remove the resist following etching because it is converted to silicon dioxide during the development process. The materials and steps described herein for fabrication of an embodiment of the inventive waveguide device are intended to be exemplary only. As will be recognized by those of skill in the art, other waveguide materials may be used, and appropriate processing parameters selected, to effect the described waveguide perturbations.

The nominal dimensions of an experimental device used for testing are 400 nm by 220 nm for the single-mode waveguide, and 600 nm by 220 nm for the multi-mode waveguide. The perturbation in the experimental device was created by modulating the waveguide widths by 10% in a square wave pattern with a period of 392 nm and a total length of 383 periods (−150 microns). The amount of change in the waveguide width at each perturbation may be varied, e.g., from 1% to 90%, depending on the conditions needed to achieve the desired degree of interaction at the subject wavelengths according to the relationships set forth in equations (1)-(3) above.

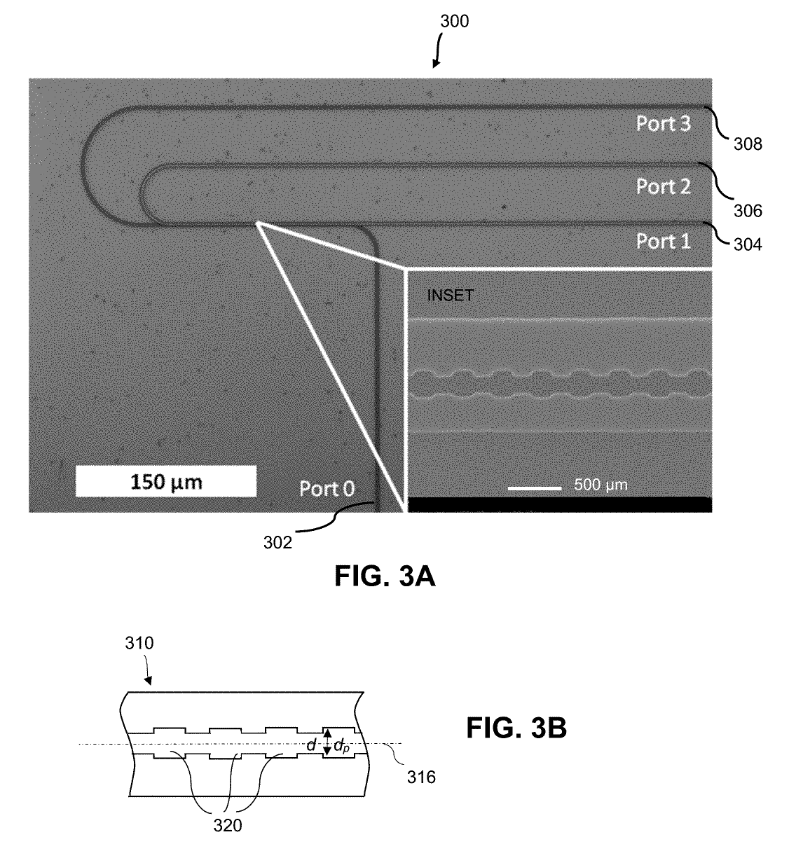

Referring briefly to the inset in FIG. 3A, which is an SEM image of the waveguide core of an actual multimode fiber fabricated in a silicon-on-insulator (SOI) waveguide, the periodic perturbation is produced by the periodic step function modulation in the waveguide sidewalls. An example of a periodic structure for the waveguide is indicated diagrammatically in a short section of an exemplary waveguide core 310 shown in FIG. 3B. The perturbations 320 are shown as periodic steps at which the waveguide width d increases to dₚ along the length of the waveguide core. It should be noted that the perturbations shown in the figure are examples only and are not intended to be limiting. As will be readily apparent to those in the art, there are numerous possible approaches for inducing perturbations in the waveguide. For example, the perturbations may be based on a sine function and may include geometric shapes consisting of half-circles or ovals, diamonds, hexagons or other polygons. The object of the perturbations is to induce mode coupling at periodic locations along the length of a segment of the waveguide. In addition, smoothing or beveling of angular surfaces (e.g., corners) of a periodic structure such as that illustrated in FIG. 3B may be appropriate to reduce losses due to diffraction and/or reflection. In some embodiments, the segment of the waveguide that includes the perturbations 320 will be limited to only a predetermined length of the total waveguide path 316, with the location of the perturbations being determined based on where overlap occurs between pairs of adjacent modes.

The input port of the device is tapered to a width of 200 nm to facilitate coupling from the lensed tapered fiber. Using a refractive index of 3.48 for silicon and 1.46 for silicon dioxide and a wavelength of 1490 nm the calculated effective refractive index of the first order mode is 2.25, and the second order mode is 1.73. For these dimensions, the predicted band center is 1560 nm, which is within 5% of the experimental value. This discrepancy is a consequence of the variation inherent in the fabrication process, and the approximations inherent in formulating the coupled-mode interaction through perturbation theory. Generally speaking, the impact of fabrication variation may be reduced by increasing the scale of the device, and the impact of the theoretical approximations may be reduced by making the dielectric modulation more perturbative.

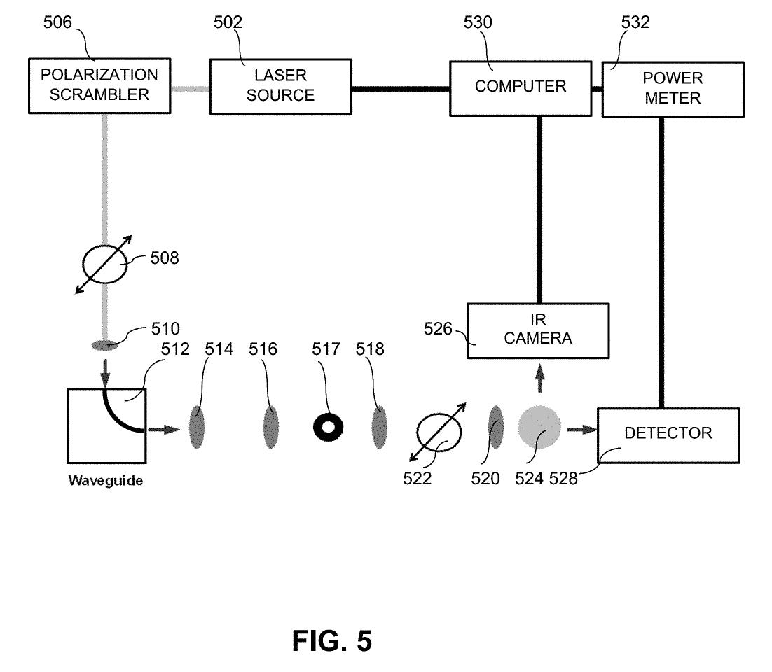

The characterization of the multiplexer was performed using the experimental setup 500 illustrated in FIG. 5. The tunable laser source 502 (Agilent model 81980A) is fiber coupled via fiber 504 to a polarization scrambler 506, a fiber polarizer 508, and a lensed tapered fiber 510. The input of the waveguide 512 is excited by the lensed tapered fiber 510, and a microscope objective lens 514 is used to collect the output. The light is then imaged on a detector by two sequential 4F systems (formed by lenses 514, 516, and 518, 520). The iris 517 in the first focal plane serves to eliminate stray light from around the waveguide output, and a polarizer 522 in the second Fourier plane is used to reject any unwanted polarization component that might arise from imperfect alignment of the input lensed tapered fiber. A removable mirror 524 in the optical path can be used to direct the waveguide output to an infrared camera 526 (ICI model Alpha NIR) for imaging, or a detector 528 (Newport model 918D-IG-OD3) for power characterization. Measurements are automated by a computer 530 that coordinates the laser source 502 and power meter 532 (Newport model 2936-R). The uncertainty in each power measurement is ±1%, and the variation of source output power versus wavelength is less than ±6%. The nominal laser output for the experimental measurement was 10 dBm, however coupling to the waveguide 512 was suboptimal because the output of the lensed tapered fiber 510 was defocused to minimize impact of mechanical drift over the course of the measurement.

The exemplary embodiment shown in FIG. 3A is an SDM coupler 300 with four ports 302, 304, 306 and 308. The coupler 300 transfers energy from the fundamental TE-mode of the single mode input waveguide at Port 0 (302) (from e.g., the j^{th} host 208 in FIG. 2) to the counter-propagating second order TE-mode of the multimode output waveguide at Port 1 (304) (forming a connection of the j^{th} host to the multimode waveguide) about a resonance wavelength. Energy not transferred by the coupler remains in the single mode waveguide and ultimately exits the device at Port 3 (308), used here to help detect how much energy from Port 0 (302) has been converted to the multimode waveguide at Port 1 (304) via the multimode converter. To verify that the coupling occurred between the desired modes, the intensity profile at the device output ports was characterized using an infrared camera.

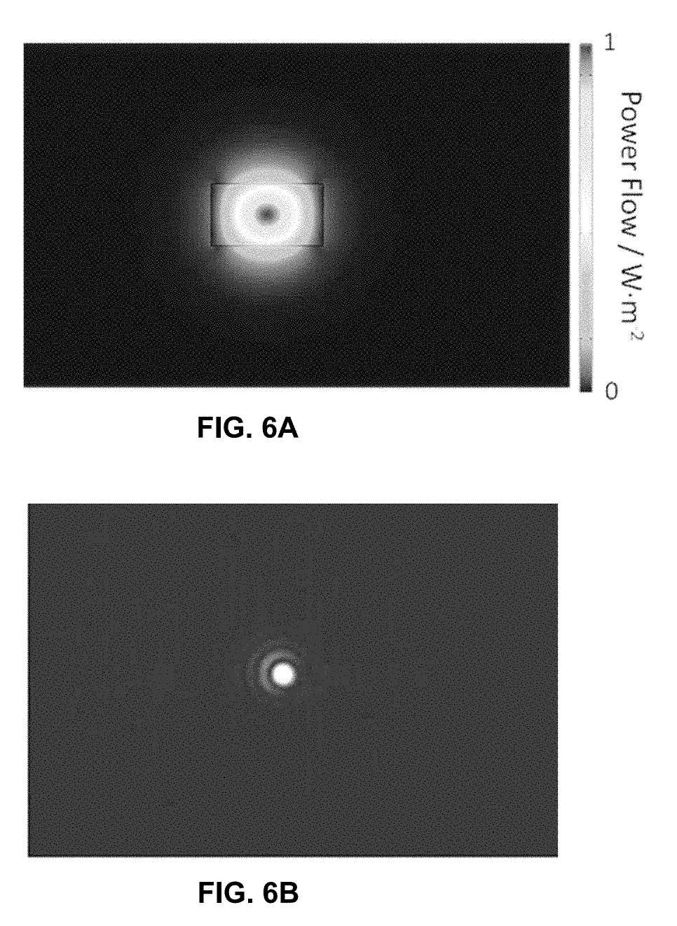

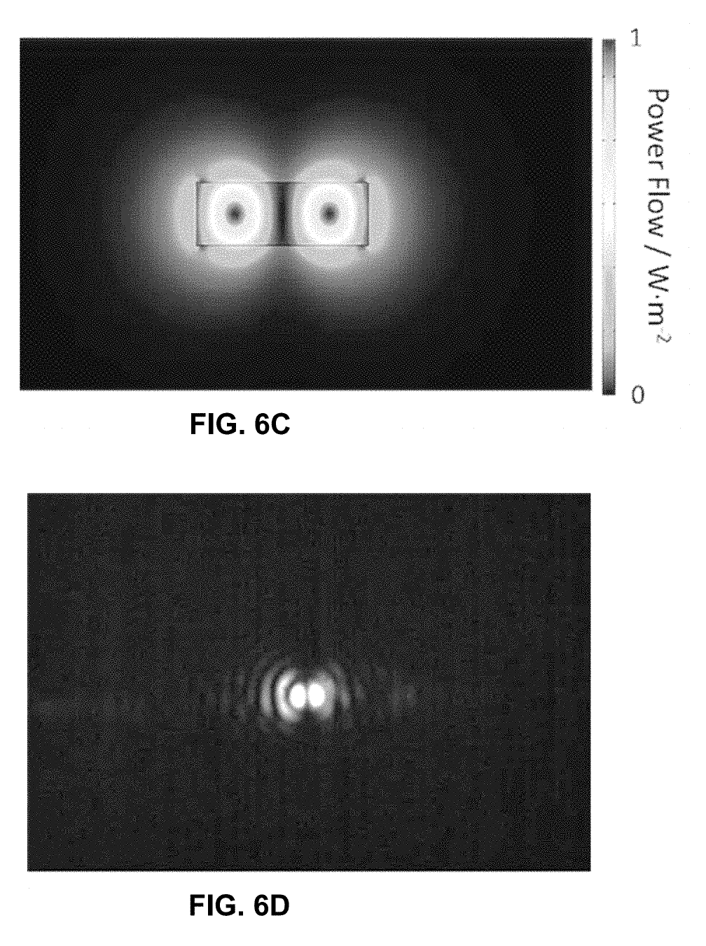

The results of testing the embodiment shown in FIG. 3A are presented in FIGS. 6A and 6C along with the theoretically predicted intensity profiles (FIGS. 5B and 5D). Away from the resonance wavelength of the coupler, the optical energy remains in the single mode waveguide, which is in accordance with the theoretical and experimental profiles, respectively, of the fundamental mode in FIGS. 6A and 6B. The excellent agreement of the theoretical and experimental second order mode profiles in FIGS. 6C and 6D at the resonance wavelength of the coupler makes it clear that the selective excitation of higher order modes in the multimode waveguide was successful. The distinct null in the center of the experimental second order mode profile of FIG. 6C is a strong indication that no incidental coupling occurred into the symmetric lower order modes.

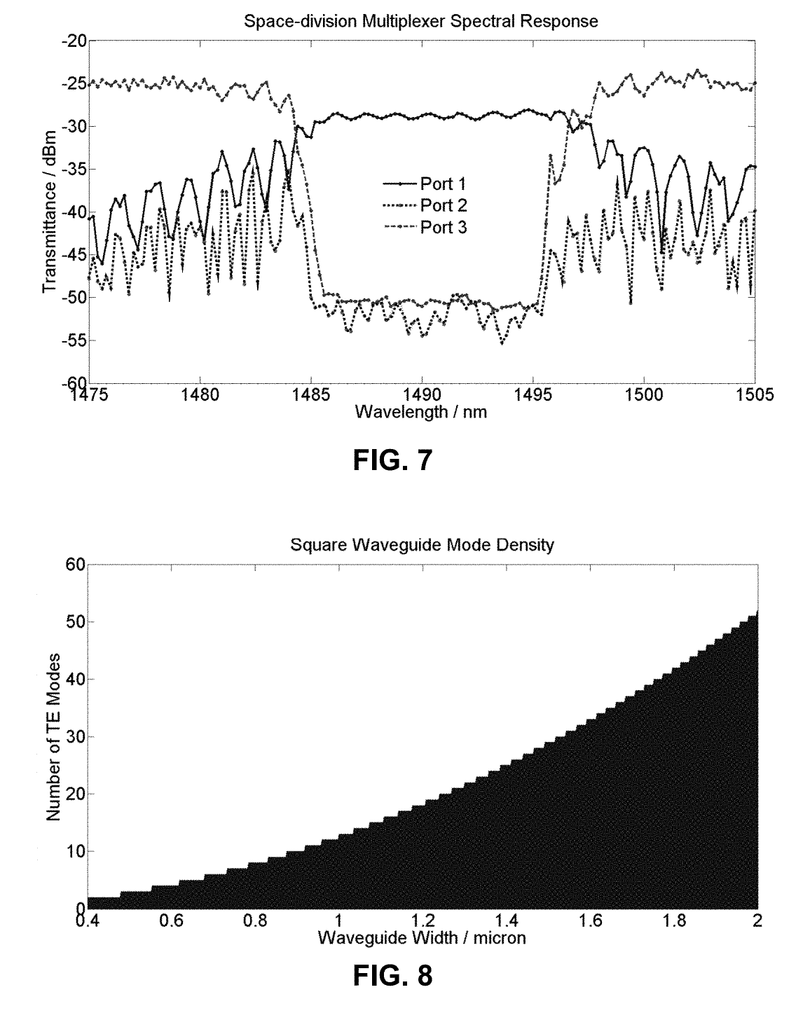

The transmission spectra of the device output ports (Port 1 (304 in FIG. 3), Port 2 (306) and Port 3 (308) are presented in FIG. 7. The mode coupling occurs in a 10 nm broad wavelength band centered at ˜1490 nm, with a maximum extinction of ˜22 dB. Note that such a design can tolerate the wavelength fluctuations that may occur in low cost transceivers from numerous hosts connected to our SDM switch, leading to the robustness of our approach. The total loss of the experimental coupler is ˜3 dB. This loss is a consequence of mode mismatch between the unperturbed waveguide and the periodically structured device. It has been demonstrated experimentally that by tapering the transition to the periodic perturbation that this source of loss can be eliminated. Such tapers would not appreciably contribute to the length of the device. Otherwise, the loss of the structure will approach that of the unperturbed waveguide, which is typically around ˜5 dB/cm, indicating that for a total device length of up to 1 mm the net losses are negligible.

A primary figure of merit of a multiplexing scheme is the number of channels it can support. In this case, the fundamental channel limit is the maximum number of modes supported by the waveguide. The number of TE (or equivalently TM) modes supported by a strip waveguide with square cross section may be expressed approximately as:

$$M \approx \frac{π}{4} {( \frac{2 \cdot d}{{λ}_{0}} )}^{2} ( {n}_{core}^{2} - {n}_{cladding}^{2} ) . \qquad ( 4 )$$

In this expression M represents the mode number (when rounded down), d is the waveguide width, λ₀ is the free-space wavelength, and n is the waveguide refractive index.

The TE (or equivalently TM) mode density in a typical silicon-on-insulator waveguide is plotted in FIG. 8 in accordance with equation (4). The mode density is calculated for a free-space wavelength of 1550 nm, a core refractive index of 3.48 (corresponding to silicon) and a cladding refractive index of 1.46 (corresponding to silicon dioxide). A 2 micron wide square waveguide with these parameters supports 50 TE modes and 50 TM modes. Based on these results, it is clear that SDM channel density compares favorably with WDM even when considered as a standalone technology.

In the context of scalability, it is much more efficient to avoid optical-electronic conversion and perform switching optically whenever possible. Existing WDM optical interconnect architectures rely on thermal switching mechanisms. For a nanosecond SDM interconnect architecture there are a limited number of physical mechanisms available that are capable of switching at the required speed, carrier injection being the most proven technology. Devices based on these effects operate using the dependence of waveguide refractive index on the temperature or carrier density. The refractive index of the waveguide alters the effective index of the guided modes, and thereby the longitudinal phase matching condition of the SDM coupler. This may be used to tune the coupler between modes, or spoil the coupling, since the phase matching condition is very stringent. Assuming that the tuning response of each waveguide is the same, for a switching effective index change of Δn_{eff} the maximum channel bandwidth is Δλ_{BW}=4·Λ·m·Δn_{eff} for grating order m.

According to embodiments of the invention, selective coupling between arbitrary waveguide modes is induced by a periodically structured waveguide (see, e.g., FIG. 3). This is an extremely versatile design that possesses a number of distinct advantages in the context of SDM, namely that the coupler occupies a small area, resulting in a small device footprint and high packing density, the bandwidth of the device can be engineered arbitrarily large or small, and may be controlled independently of the mode coupling, and there is no fundamental limit on the number of higher order modes that can be excited. It should be noted that each coupler can be reprogrammed to operate with a large number of different spatial modes, topologically enabling realization of crossbar switching.

The inventive approach may also be used as a switch by varying the mode coupling strength, which may be controlled by varying the physical dimensions or refractive index of the waveguide. This is possible because such changes alter the wavenumbers of the interacting modes and/or periodic structure, and therefore, the phase matching condition.

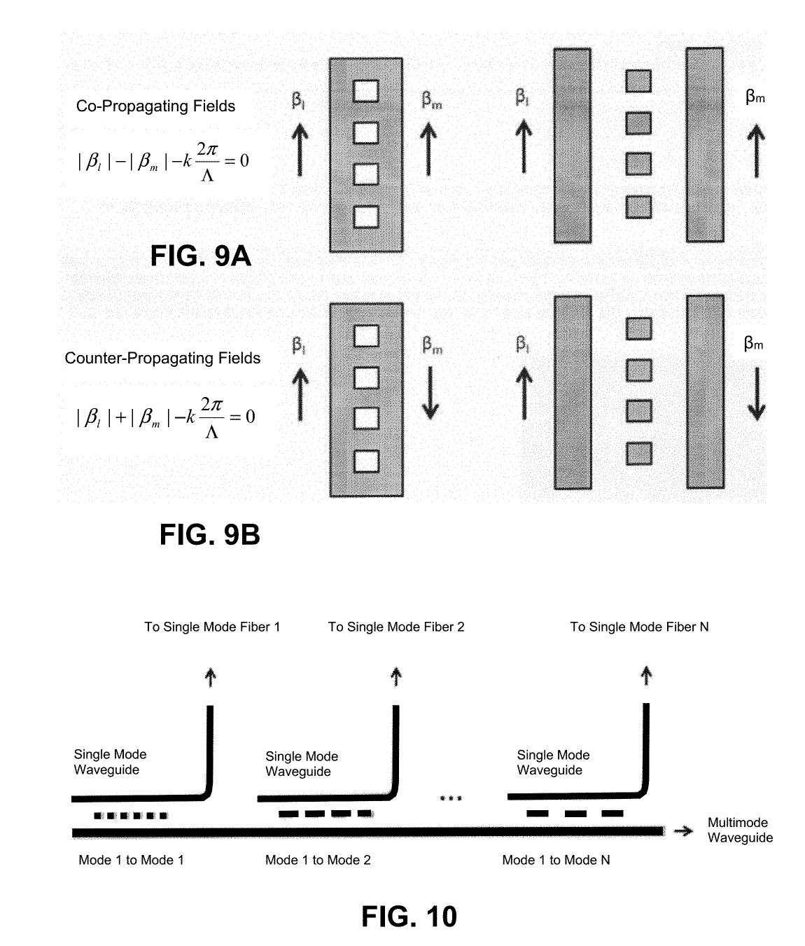

FIGS. 9A and 9B provide a diagrammatic illustration of example of mode coupling waveguide arrangements constructed using to the inventive approach. FIG. 9A shows a coupling for co-propagating fields (βₗ and βₘ in the same direction, as indicated by the arrows) under the conditions

$$\vert {β}_{l} \vert - \vert {β}_{m} \vert - k \frac{2 π}{Λ} = 0 ,$$

while FIG. 9B shows a coupling for counter-propagating fields (βₗ and βₘ in opposite directions, as indicated by the arrows) under the conditions

$$\vert {β}_{l} \vert + \vert {β}_{m} \vert - k \frac{2 π}{Λ} = 0.$$

FIG. 10 illustrates a potential application of the inventive approach for implementing a mode-division multiplexing device with mode selective couplers coupling to single mode fibers #1 through #N. The inventive SDM coupling approach advantageously minimizes optical loss by limiting the perturbations to the space where the modes maximally overlap. For integrated waveguides the dominant source of loss is scattering produced by roughness in the waveguide sidewalls. Consequently, increasing the waveguide dimensions will actually reduce loss because less of the mode overlaps with the waveguide sidewalls. This can be contrasted with single mode couplers described by D. T. H. Tan, et al. (“Monolithic nonlinear pulse compressor on a silicon chip,” Nature Communications, vol. 1, p. 116, 2010; and “Wide bandwidth, low loss 1 by 4 wavelength division multiplexer on silicon for optical interconnects,” Optics Express, vol. 19, pp. 2401-2409, 2011.) Such prior art devices have perturbations on the outside of waveguides where the mode overlap is negligible. As a result, the contribution of such perturbations to the coupling coefficient is negligible while the loss contributions from increased sidewall area is nontrivial.

The SDM coupler described herein has significant implications for optical networking. The device mitigates the shortcomings of alternative SDM schemes, by possessing advantages in terms of packing density, bandwidth freedom, and channel support. Furthermore, the periodic structure that forms the backbone of the device can be used to perform additional signal processing functions with minimal impact on the device footprint. Integrated SDM has the potential to reduce the cost and complexity of networking systems, either by improving scalability through the augmentation of existing WDM schemes, or as a standalone technology by eliminating the need for costly WDM components.

Among the many potential applications of the technology are three main immediate commercial applications of the invention. The first is as a stand-alone multiplexer. The commercial incarnation of the device will most likely be passive, or operate using slow (millisecond to microsecond} switching technology (e.g., the thermo-optic effect). In this capacity the device will function as any other standard removable optical component. The second is as an integrated multiplexer and high speed switch hybrid. The commercial incarnation of this device will most likely operate using a fast (nanosecond) switching technology (e.g., carrier injection). In this capacity the device will function as an all optical packet switch and may functionally replace the electronic top of the rack switch. The third is as an optical crossbar switch which can efficiently route incoming optical signals to the appropriate out-bound channels, whether one-to-one or one to many, with broad applications in telecommunications and internet data trafficking.

### REFERENCES

### Incorporated Herein by Reference

1. Y. Fainman and G. Porter, “Directing Data Center Traffic,” Science, vol. 342, pp. 202-203, 2013.
2. N. Farrington, et al., “Hunting Mice with Microsecond Circuit Switches,” in ACM HotNets, Redmond, Wash., 2012.
3. N. Farrington, et al., “A Demonstration of Ultra-Low-Latency Datacenter Optical Circuit Switching,” in ACM SIGCOMM, Helsinki, Finland, 2012.
4. G. Porter, et al., “Integrating Microsecond Circuit Switching into the Data Center,” in ACM SIGCOMM, Hong Kong, China, 2013.
5. K.-P. Ho and J. M. Kahn, “Mode Coupling and its Impact on Spatially Multiplexed Systems,” in Optical Fiber Telecommunications VI, Amsterdam, Elsevier, 2013, pp. 491-568.
6. L.-W. Luo et al., “WDM-compatible mode-division multiplexing on a silicon chip,” Nature Communications, vol. 5, p. 3069, 2014.
7. S. O. Arik, et al., “MIMO Signal Processing for Mode-Division Multiplexing: An overview of channel models and signal processing architectures,” Signal Processing Magazine, vol. 31, pp. 25-34, 2014.
8. S. Berdagué and P. Facq, “Mode division multiplexing in optical fibers,” Applied Optics, vol. 21, pp. 1950-1955, 1982.
9. H. R. Stuart, “Dispersive Multiplexing in Multimode Optical Fiber,” Science, vol. 289, pp. 281-283, 2000.
10. R. Rokitski and Y. Fainman, “Propagation of ultrashort pulses in multimode fiber in space and time,” Optics Express, vol. 11, pp. 1497-1502, 2003.
11. L. B. Soldano and E. C. M. Pennings, “Optical Multi-Mode Interference Devices Based on Self-Imaging: Principles and Applications,” Journal of Lightwave Technology, vol. 13, pp. 615-627, 1995.
12. Y. Huang, G. Xu and S.-T. Ho, “An Ultracompact Optical Mode Order Converter,” Photonic Technology Letters, vol. 18, pp. 2281-2283, 2006.
13. A. Grieco and Y. Fainman, “Characterization of Distributed Bragg Reflectors,” Journal of Quantum Electronics, vol. 50, pp. 453-457, 2014.
14. A. Grieco, et al., “Characterization of waveguide loss using distributed Bragg reflectors,” Applied Physics B, vol. 114, pp. 467-474, 2014.
15. B. E. A. Saleh and M. C. Teich, “7.3 Two-Dimensional Waveguides,” in Fundamentals of Photonics, New York, John Wiley & Sons, 1991, pp. 259-261.
16. S. Homampour, et al., “Thermal tuning of planar Bragg gratings in silicon-on-insulator rib waveguides,” Physica Status Solidi C, vol. 6, pp. S240-S243, 2009.
17. X. Wang, et al., “Compact Thermally Tunable Silicon Wavelength Switch: Modeling and Characterization,” Photonics Technology Letters, vol. 20, pp. 936-938, 2008.
18. R. A. Soref and B. A. Bennett, “Electrooptical Effects in Silicon,” Journal of Quantum Electronics, Vols. QE-23, pp. 123-129, 1987.
19. C. Li, et al., “Silicon microring carrier-injection-based modulators/switches with tunable extinction ratios and OR-logic switching by using waveguide cross-coupling,” Optics Express, vol. 15, pp. 5069-5076, 2007.
20. D. T. H. Tan, et al., “Monolithic nonlinear pulse compressor on a silicon chip,” Nature Communications, vol. 1, p. 116, 2010.
21. Y. Kawaguchi and K. Tsutsumi, “Mode multiplexing and demultiplexing devices using multimode couplers,” Electronics Letters, pp. 1701-1702, 2002.
22. A. Yariv and P. Yeh, Optical Waves in Crystals: Propagation and Control of Laser Radiation, Hoboken, N.J.: John Wiley & Sons, 2003.
23. H. Kogelnik, “2. Theory of Dielectric Waveguides,” in Integrated Optics (Topics in Applied Physics), Berlin, Del., Springer-Verlag, 1975, pp. 13-81.
24. D. J. Richardson, et al., “Space-division multiplexing in optical fibres,” Nature Photonics, vol. 7, p. 94, 2013.
25. H.-C. Kim, et al., “Tunable Transmission Resonant Filter and Modulator With Vertical Gratings,” Journal of Lightwave Technology, vol. 25, pp. 1147-1151, 2007.
26. K. Ikeda, et al., “Wavelength selective coupler with vertical gratings on silicon chip,” Applied Physics Letters, vol. 92, p. 201111, 2008.
27. D. T. H. Tan, et al., “Wide bandwidth, low loss 1 by 4 wavelength division multiplexer on silicon for optical interconnects,” Optics Express, vol. 19, pp. 2401-2409, 2011.
28. D. T. H. Tan, et al., “Cladding-modulated Bragg gratings in silicon waveguides,” Optics Letters, vol. 34, pp. 1357-1359, 2009.
29. M. W. Puckett, et al., “Tensor of the second-order nonlinear susceptibility in asymmetrically strained silicon waveguides: analysis and experimental validation,” Optics Express, vol. 39, pp. 1693-1696, 2014.
30. B. Chmielak, et al., “Pockels effect based fully integrated, strained silicon electro-optic modulator,” Optics Express, vol. 19, pp. 17212-17219, 2011.
31. S. Homampour, et al., “Thermal tuning of planar Bragg gratings in silicon-on-insulator rib waveguides,” Physica Status Solidi C, vol. 6, pp. S240-S243, 2009.
32. O. Bondarenko, et al., “Wafer bonded distributed feedback laser with sidewall modulated Bragg gratings,” Applied Physics Letters, vol. 103, p. 043105, 2013.
33. M. P. Nezhad, et al., “Room-temperature subwavelength metallo-dielectric lasers,” Nature Photonics, vol. 4, pp. 395-399, 2010.
34. O. Bondarenko, et al., “Wafer Bonded Subwavelength Metallo-Dielectric Laser,” IEEE Photonics Journal, vol. 3, pp. 608-616, 2011.
35. U. Hoelzle and L. A. Barroso, The Datacenter as a Computer: An Introduction to the Design of Warehouse-Scale Machines, 1st Ed., Morgan and Claypool Publishers, 2009.
36. H. Bazzaz, et al., “Switching the Optical Divide: Fundamental Challenges for Hybrid Electrical/Optical Datacenter Networks,” in Proceedings of the ACM Symposium on Cloud Computing (SOCC), Cascais, Portugal, 2011.
37. K. Chen, et al., “OSA: an optical switching architecture for data center networks with unprecedented flexibility,” in NSDI'12 Proceedings of the 9th USENIX conference on Networked Systems Design and Implementation, San Jose, Calif., 2012.
38. N. Farrington, et al., “Helios: A Hybrid Electrical/Optical Switch Architecture for Modular Data Centers,” in SIGCOMM'10, New Delhi, India, 2010.
39. N. Farrington, et al., “Hardware Requirements for Optical Circuit Switched Data Center Networks,” in Optical Fiber Communication Conference (OFC/NFOEC), Los Angeles, Calif., 2011.
40. G. Wang, et al., “c-Through: Part-time Optics in Data Centers,” in SIGCOMM'10, New Delhi, India, 2010.
41. C. Martinez, et al., “Apodized fiber Bragg gratings manufactured with the phase plate process,” Applied Optics, vol. 41, pp. 1733-1740, 2002.
42. A. Hayat and M. Orenstein, “Standing-wave nonlinear optics in an integrated semiconductor microcavity,” Optics Letters, vol. 32, pp. 2864-2866, 2007.
43. Y. Fainman and G. Porter, “Directing Data Center Traffic,” Science, vol. 342, p. 202, 2013.
44. A. Grieco and Y. Fainman, “Characterization of Distributed Bragg Reflectors,” Journal of Quantum Electronics, vol. 50, pp. 453-457, 2014.
45. K. M. A. Simic, et al., “Thresholdless nanoscale coaxial lasers,” Nature, vol. 482, pp. 204-207, 2012.
46. H. Liu, et al., “Circuit Switching Under the Radar with REACToR,” in Proceedings of the 11th ACM/USENIX Symposium on Networked Systems Design and Implementation (NSDI), Seattle, Wash., 2014.
47. M. Walraed-Sullivan, et al., “Aspen Trees: Balancing Data Center Fault Tolerance, Scalability and Cost,” in CoNEXT, Santa Barbara, Calif., 2013.
48. F. Grillot, et al., “Size Influence on the Propagation Loss Induced by Sidewall Roughness in Ultrasmall SOI Waveguides,” Photonics Technology Letters, vol. 16, pp. 1661-1663, 2004.
49. D. K. Sparacin, et al., “Silicon Waveguide Sidewall Smoothing by Wet Chemical Oxidation,” Journal of Lightwave Technology, vol. 23, pp. 2455-2461, 2005.

1. A multi-mode optical waveguide device comprising a plurality of periodically structured waveguides disposed adjacent each other on a substrate, each waveguide configured to guide a carrier signal comprising one spatial mode of a plurality of spatial modes, wherein at least one segment of each waveguide has a waveguide width that periodically changes along a waveguide path to induce coupling between pairs of spatial modes.

2. The multi-mode optical waveguide device of claim 1, wherein the at least one segment is disposed at a location along the waveguide path at which maximal mode overlap occurs.

3. The multi-mode optical waveguide device of claim 1, wherein the substrate comprises silicon-on-insulator.

4. The multi-mode optical waveguide device of claim 1, wherein the waveguide comprises a silicon core and a silicon dioxide cladding.

5. The multi-mode optical waveguide device of claim 1, wherein a periodic change in the waveguide width corresponds to a step function or sine function.

6. The multi-mode optical waveguide device of claim 1, wherein periodic changes in the waveguide width are configured to induce longitudinal phase matching between the spatial modes of a pair of spatial modes.

7. A space-division multiplexer comprising the multi-mode optical waveguide device of claim 1.

8. An optical switch comprising the multi-mode optical waveguide device of claim 1, wherein one or more of physical dimensions and refractive index of the plurality of waveguides are configured to control mode coupling strength.

9. A multi-mode waveguide device for multiplexing a plurality of carrier signals having a plurality of spatial modes, the waveguide device comprising:
a plurality of waveguides, each waveguide configured to guide a carrier signal comprising one spatial mode of the plurality of spatial modes, each waveguide having a waveguide path wherein at least a portion of the waveguide path has formed therein a plurality of periodic perturbations configured to induce coupling between pairs of spatial modes of the plurality of spatial modes.

10. The multi-mode waveguide device of claim 9, wherein the at least a portion is disposed at a location along the waveguide path at which maximal mode overlap occurs.

11. The multi-mode waveguide device of claim 9, wherein the substrate comprises silicon-on-insulator.

12. The multi-mode waveguide device of claim 9, wherein the waveguide comprises a silicon core and a silicon dioxide cladding.

13. The multi-mode waveguide device of claim 9, wherein the periodic perturbations correspond to a step function or a sine function.

14. The multi-mode waveguide device of claim 9, wherein the periodic perturbations are configured to induce longitudinal phase matching between the spatial modes of a pair of spatial modes.

15. A space-division multiplexer comprising the multi-mode waveguide device of claim 9.

16. An optical switch comprising the multi-mode waveguide device of claim 9, wherein one or more of physical dimensions and refractive index of the plurality of waveguides are configured to control mode coupling strength.

17. A method for multiplexing a plurality of carrier signals comprising a plurality of different spatial modes, the method comprising:
inputting each carrier signal into an input port of a waveguide of a plurality of waveguides, each waveguide having a waveguide path wherein at least a portion of the waveguide path has formed therein a plurality of periodic perturbations configured to induce coupling between pairs of spatial modes of the plurality of spatial modes.

18. The method of claim 17, wherein the plurality of periodic perturbations correspond to a step function or a sine function.

19. The method of claim 17, wherein the plurality of periodic perturbations are configured to induce longitudinal phase matching between the spatial modes of a pair of spatial modes.
